(19) United States
(12) Patent Application Publication
(10) Pub. No.: US 2010/0028000 A1
(43) Pub. Date: Feb. 4, 2010

(54) MODULE WITH BOTH ANALOG AND DIGITAL RECEIVING-TRANSMITTING

(75) Inventors: Hui-Tsuo Chou, Taipei (TW); Allen Ho, Taipei (TW)

Correspondence Address: PAI PATENT & TRADEMARK LAW FIRM, 1001 FOURTH AVENUE, SUITE 3200, SEATTLE, WA, 98154, US

(73) Assignee: Allen Ho, Taipei (TW)

(21) Appl. No.: 12/097,519

(22) PCT Filed: Dec. 16, 2005
(86) PCT No.: PCT/CN2005/002222

§ 371 Date: Sep. 19, 2009

(51) Int. Cl. H04J 14/02; H04B 10/00

(52) U.S. Cl. 398/79; 398/139

(57) ABSTRACT

A module with both analog and digital receiving-transmitting is provided, which has an optical signal transceiving terminal, an optical signal receiving terminal, a wavelength division unit, a first optical-to-electrical transceiver unit, and a second optical-to-electrical output unit. The first optical-to-electrical transceiver unit is connected to the optical signal transceiving terminal for optical-to-electrical process of computer data communication. The second optical-to-electrical output unit is connected to the optical signal receiving terminal for optical-to-electrical process of analog image signals.

### BACKGROUND OF THE INVENTION

1. Field of the Invention

The present invention relates to a module with both analog and digital receiving-transmitting. More particularly, the present invention relates to a module with both analog and digital receiving-transmitting that integrates kinds of optical-to-electrical processes of fiber-to-the-home application.

2. Description of the Prior Art

Fiber-to-the-home (FTTH) means extending optical fiber network into families. That is, the network connections between families are composed of optical fibers. The optical fiber network is configured to transmit computer data, cable TV images, voice communication, and to realize high-speed data transmission and twenty-four hours continuous network function. FIG. 1A and FIG. 1B illustrate conventional FTTH structure of processing the computer data signals and the cable TV signals. The conventional FTTH structure needs two independent receivers for receiving two kinds of signals.

As shown in FIG. 1A, the optical signal with wavelength λ1 is fed into the optical fiber 8. A cable TV signal receiver unit 81 then transfers the optical signal into a RF signal and transmits the RF signal to the TV 7. The cable TV signal receiver unit 81 comprises a photo detector 811, an amplifier 812, a line driver 813, and a RF connector 814. The photo detector 811 is configured to transfer the optical signal into a small current signal. The small current signal is amplified by the amplifier 812 and is sent to the line driver 813 for driving the signal. Then the RF connector 814 is configured to transmit signals to the TV 7.

In the other hand, the flow for processing the computer data is shown in FIG. 1B. An optical communication transceiver 91 is configured to ensure the download and upload processes of the data communication. During download process, the optical signal with wavelength λ2 is fed into a photo-detector 911 with trans-impedance amplifier for transferring the digital optical signal into a small current and then transferring into a small voltage signal by the trans-impedance amplifier. Then a limiting amplifier 912 is configured to transfer the small voltage signal into a differential signal for a backend network chip 913. The backend network chip 913 is connected to the computer 6 via a RJ-45 connector 914. During upload process, the backend network chip 913 is configured to provide upload signal, and a laser driver unit 915 is configured to drive a laser emit diode (LED) for emitting the digital optical signal with wavelength λ3. The digital optical signal is then transmitted via a single-core optical fiber.

By the aforementioned description, it is understood that conventional designs do not integrate optical data communication and the optical cable TV signal process. The transceiver unit for data communication and the receiver unit of the cable TV are independent. Thus the backend application designers are hard to deal with the conventional designs and the users have to buy two kinds of products, also, the whole occupying space of the system is wasted. As aforementioned description, the conventional transmission process of the computer data signals and the cable TV signals are in duplex transmission mode, but not in wavelength division multiplexing (WDM) mode, and thus the high transmission capability of optical fiber can not be fully used.

### SUMMARY OF THE INVENTION

The primary objective of the present invention is to provide a module with both analog and digital receiving-transmitting that can highly integrate data communication optical signals and cable-TV signals to prevent drawbacks of current arts.

The module with both analog and digital receiving-transmitting that can achieve the aforementioned objective comprises: an optical signal transceiving terminal, being configured to transceive a first optical signal; a wavelength division unit, being configured to divide the first optical signal transceived by the transceiving terminal with different wavelengths, and being wavelength division multiplexing, WDM; a first optical-to-electrical transceiver unit, being connected to the optical signal transceiving terminal for converting the first optical signal, and transceiving a first electrical signal; an optical signal receiving terminal, being configured to receive a second optical signal; a second optical-to-electrical output unit, being connected to the optical signal receiving terminal for converting the second optical signal, and outputting a second electrical signal.

The module with both analog and digital receiving-transmitting characterized in that the first optical signal is a digital optical signal.

The module with both analog and digital receiving-transmitting characterized in that the second optical signal is a simulated optical signal.

The module with both analog and digital receiving-transmitting characterized in that the first electrical signal is a digital electrical signal.

The module with both analog and digital receiving-transmitting characterized in that the second electrical signal is an analog electrical signal.

The module with both analog and digital receiving-transmitting characterized in that the first optical-to-electrical transceiver unit comprises: a laser emit diode (LED); a laser driver unit, being configured to receive the first electrical signal to drive the LED, and to emit the first optical signal via the optical signal transceiving terminal; an photo detector, having a trans-impedance amplifier, TIA, that is configured to transfer the first optical signal into a voltage signal; a limiting amplifier, being configured to transfer the voltage signal into a differential signal; and an electrical signal transceiving terminal, being configured to transceive the differential signal.

The module with both analog and digital receiving-transmitting characterized in that the second optical-to-electrical output unit comprises: an photo detector, being configured to transfer the second optical signal into a current signal; an amplifier, being configured to amplify the current signal; a line driver, being configured to drive the current signal; and a electrical signal output terminal, being adapted to output the current signal as a second electrical signal.

The module with both analog and digital receiving-transmitting characterized in that the electrical signal output terminal is set with an output interface connector unit.

The module with both analog and digital receiving-transmitting characterized in that the output interface connector unit is composed of an F-type connector.

The module with both analog and digital receiving-transmitting characterized in that the output signal transceiving terminal is set with an optical interface connector head for connection.

The module with both analog and digital receiving-transmitting characterized in that the optical interface connector head is selected from groups of dual-SC-type connector head, dual-ST-type connector head, dual-FC-type connector head, and dual-LC-type connector head.

The module with both analog and digital receiving-transmitting characterized in that the optical signal receiving terminal is set with an optical interface connector head for connection.

The module with both analog and digital receiving-transmitting characterized in that the optical interface connector head is selected from groups of dual-SC-type connector head, dual-ST-type connector head, dual-FC-type connector head, and dual-LC-type connector head.

The module with both analog and digital receiving-transmitting characterized in that the electrical signal transceiving terminal is set with a transceiving interface connector unit.

The module with both analog and digital receiving-transmitting characterized in that the transceiving interface connector unit is composed of pin-type head.

The present invention provides a module with both analog and digital receiving-transmitting comprising: an optical signal transceiving terminal, being configured to transceive a first optical signal and receive a second optical signal; a wavelength division unit, being configured to divide the first optical signal transceived and the second optical signal having different bandwidths; a first optical-to-electrical transceiver unit, being connected to the wavelength division unit for converting the first optical signal, and transceiving a first electrical signal; a second optical-to-electrical output unit, being connected to the wavelength division unit for converting the second optical signal, and outputting a second electrical signal.

The module with both analog and digital receiving-transmitting characterized in that the first optical signal is a digital optical signal.

The module with both analog and digital receiving-transmitting characterized in that the second optical signal is a simulated optical signal.

The module with both analog and digital receiving-transmitting characterized in that the first electrical signal is a digital electrical signal.

The module with both analog and digital receiving-transmitting characterized in that the second electrical signal is an analog electrical signal.

The module with both analog and digital receiving-transmitting characterized in that the first optical-to-electrical transceiver unit comprises: a laser emit diode (LED); a laser driver unit, being configured to receive the first electrical signal to drive the LED, and to emit the first optical signal via the optical signal transceiving terminal; an photo detector, having a trans-impedance amplifier, TIA, being configured to transfer the first optical signal into a voltage signal; a limiting amplifier, being configured to transfer the voltage signal into a differential signal; and an electrical signal transceiving terminal, being configured to transceive the differential signal.

The module with both analog and digital receiving-transmitting characterized in that the electrical signal output terminal is set with a transceiving interface connector unit.

The module with both analog and digital receiving-transmitting characterized in that the transceiving interface connector unit is composed of pin-type head.

The module with both analog and digital receiving-transmitting characterized in that the second optical-to-electrical output unit comprises: an photo detector, being configured to transfer the second optical signal into a current signal; an amplifier, being configured to amplify the current signal; a line driver, being configured to drive the current signal; and a electrical signal output terminal, being adapted to output the current signal as a second electrical signal.

The module with both analog and digital receiving-transmitting characterized in that the electrical signal output terminal is set with an output interface connector unit.

The module with both analog and digital receiving-transmitting characterized in that the output interface connector unit is composed of an F-type connector.

The module with both analog and digital receiving-transmitting characterized in that the output signal transceiving terminal is set with an optical interface connector head for connection.

The module with both analog and digital receiving-transmitting characterized in that the optical interface connector head is selected from groups of dual-SC-type connector head, dual-ST-type connector head, dual-FC-type connector head, and dual-LC-type connector head.

Through the designs of the present invention, the module with both analog and digital receiving-transmitting is configured to integrate analog optical-to-electrical units and digital optical-to-electrical units and each signal transceiving terminal. The system manufacturers are easy to design FTTH products without dealing with complex analog/digital optical-to-electrical signal conversion. Moreover, optical communication modules are highly integrated in the module with both analog and digital receiving-transmitting to abruptly reduce the occupied space, and the user only needs to buy single product.

These features and advantages of the present invention will be fully understood and appreciated from the following detailed description of the accompanying Drawings.

### BRIEF DESCRIPTION OF THE DRAWINGS

FIG. 1A illustrates conventional FTTH structure of processing the cable TV signals;

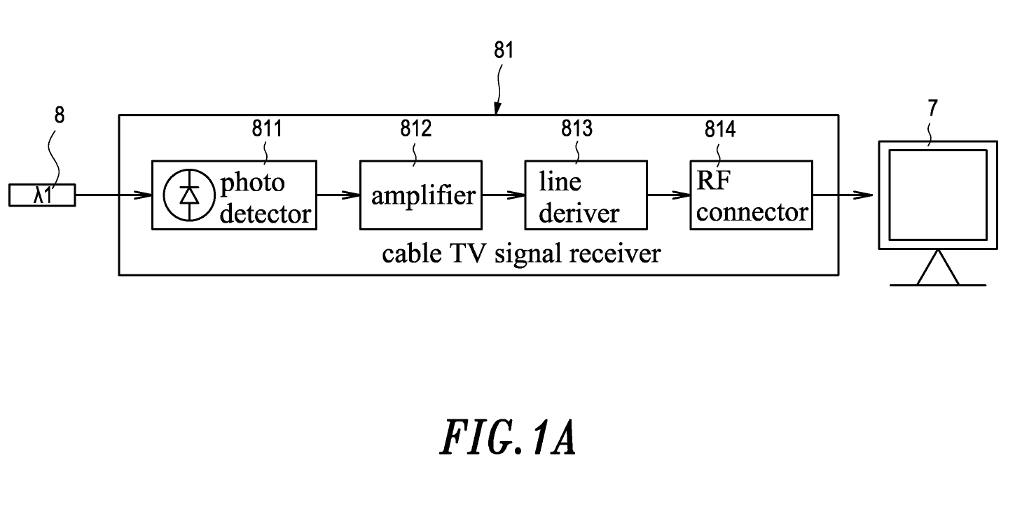

FIG. 1B illustrates conventional FTTH structure of processing the computer data signals;

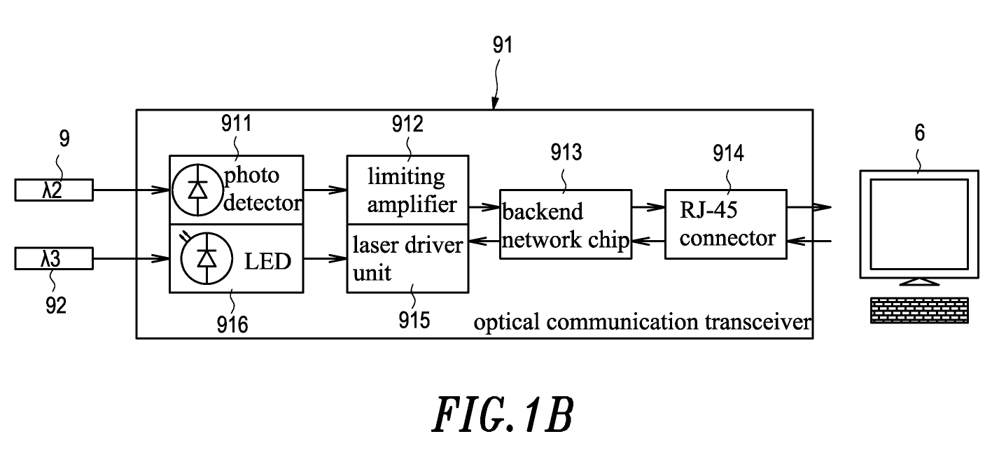

FIG. 2 illustrates a block diagram of the present invention;

FIG. 2A illustrate block diagram of the extensional structure of the present invention;

FIG. 3 illustrates another block diagram of the present invention;

FIG. 4A illustrates the front view diagram of the module with both analog and digital receiving-transmitting of the present invention;

FIG. 4B illustrates the three-dimensional diagram of the module with both analog and digital receiving-transmitting of the present invention;

FIG. 5A illustrates three-dimensional diagram of the module with both analog and digital receiving-transmitting of the present invention; and

FIG. 5B illustrates planer diagram of the module with both analog and digital receiving-transmitting of the present invention.

### DETAILED DESCRIPTION OF THE PREFERRED EMBODIMENT

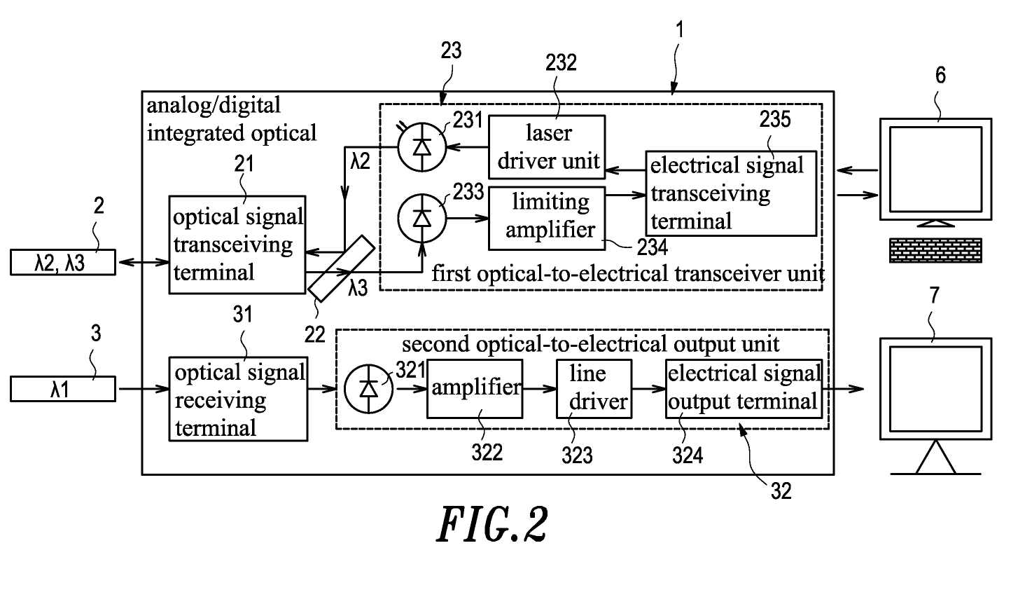

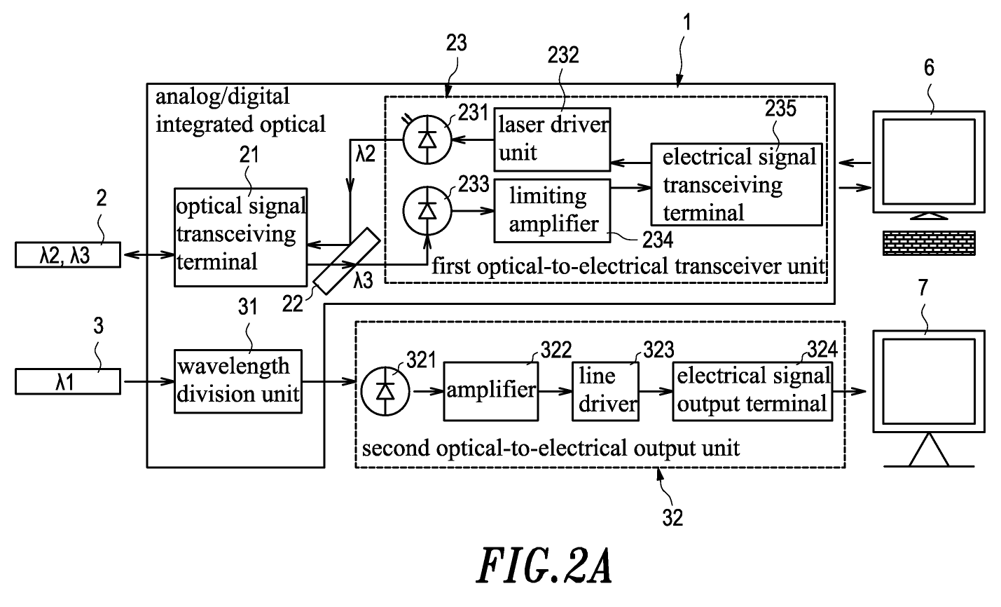

FIG. 2 illustrates a block diagram of the present invention. A module 1 with both analog and digital receiving-transmitting 1 comprises devices as follows:

an optical signal transceiving terminal 21, being configured to transceive a first optical signal, wherein the first optical signal is a digital optical signal;

a wavelength division unit 22, being configured to divide the first optical signal transceived by the transceiving terminal with different wavelengths, and being wavelength division multiplexing, WDM;

a first optical-to-electrical transceiver unit 23, being connected to the optical signal transceiving terminal 21 for converting the first optical signal, and transceiving a first electrical signal, wherein the first electrical signal is a digital electrical signal;

an optical signal receiving terminal 31, being configured to receive a second optical signal, wherein the second optical signal is a simulated optical signal

a second optical-to-electrical output unit 32, being connected to the optical signal receiving terminal 31 for converting the second optical signal, and outputting a second electrical signal, wherein the second electrical signal is an analog electrical signal.

The first optical-to-electrical transceiver unit 23 at least comprises:

a laser emit diode (LED) 231;

a laser driver unit 232, being configured to receive the first electrical signal to drive the LED 231, and to emit the first optical signal via the optical signal transceiving terminal 21;

an photo detector 233, having a trans-impedance amplifier, TIA, that is configured to transfer the first optical signal into a voltage signal;

a limiting amplifier 234, being configured to transfer the voltage signal into a differential signal; and

an electrical signal transceiving terminal 235, being configured to transceive the differential signal through the electrical signal transceiving terminal 235.

The data communication of computer 6 is fed into the laser driver unit 232 via the electrical signal transceiving terminal 235 in digital electrical signal mode to drive the LED 231. The LED 231 emits digital optical signals with wavelength λ2, the digital optical signals are transmitted to a fiber 2 via the optical signal transceiving terminal 21 for updating data communication of computer 6. Besides, the optical signal transceiving terminal 21 receives the digital optical signal with wavelength λ3 from the optical fiber 2, and feeds it into the photo detector 233 that has the trans-impedance amplifier. The digital optical signal is transferred into a small current signal and is amplified by the trans-impedance amplifier of the photo detector 233 and then transferred into a differential signal by the limiting amplifier 234 and sent to the electrical signal transceiving terminal 235. The differential signal is denoted as the digital electrical signal that is fed into the computer 6, i.e. the downloading data communication of computer 6. According to the aforementioned structure, process of data communication transmission applies design of wavelength division multiplexing (WDM). That is, the digital optical signal applied in communication transmission in the optical fiber 2 is able to carry signals with two wavelength λ2 and λ3 of to make use of bandwidth of the optical fiber 2. The digital optical signal with, λ2 emitted by the LED 231 and the digital optical signal with λ3 fed into the photo detector 233 are divided by the wavelength division unit 22.

The second optical-to-electrical output unit 32 at least comprises:

an photo detector 321, being configured to transfer the second optical signal into a current signal;

an amplifier 322, being configured to amplify the current signal;

a line driver 323, being configured to drive the current signal; and

a electrical signal output terminal 324, being adapted to output the current signal as a second electrical signal.

The digital optical signal with wavelength λ1 transmitted through the optical fiber 3 is received by the optical signal transceiving terminal 31, and is sent into the photo detector 321 of the second optical-to-electrical output unit 32. The digital optical signal is transferred into a small current signal and is amplified by the amplifier 322 and is sent to the line driver 323 for driving the signal. Then the electrical signal transceiving terminal 324 is configured to transmit signals to cable TV 7.

FIG. 2A illustrate block diagram of the extensional structure of the present invention. The second optical-to-electrical output unit 32 shown in the FIG. 2 is comprised in the module 1 with both analog and digital receiving-transmitting. In the structure shown in FIG. 2A, the second optical-to-electrical output unit 32 is separated from the module 1 with both analog and digital receiving-transmitting and is denoted as an independent unit.

In the aforementioned structure, the module 1 with both analog and digital receiving-transmitting only comprises an optical signal transceiving terminal 21, a first optical-to-electrical transceiver unit 23, and an optical signal receiving terminal 31. By the embodiment, the cost of manufacturing is reduced and the user can choose the module that is able to be connected to the computer 6 only, or the module that is able to be connected to the computer 6 and the cable TV 7.

Once the user wants to apply the optical fiber 3 on the cable TV 7, the user needs an external second optical-to-electrical output unit 32 for receiving the simulated optical signal transmitted by the optical signal receiving terminal 31 of the module 1 with both analog and digital receiving-transmitting.

The second optical-to-electrical output unit 32 comprises the photo detector 321, the amplifier 322, the line driver 323, and the electrical signal transceiving terminal 324. The digital optical signal with wavelength λ1 transmitted through the optical fiber 3 is received by the optical signal transceiving terminal 31, and is sent into the photo detector 321 of the second optical-to-electrical output unit 32. The digital optical signal is transferred into a small current signal and is amplified by the amplifier 322 and is sent to the line driver 323 for driving the signal. Then the electrical signal transceiving terminal 324 is configured to transmit signals to cable TV 7.

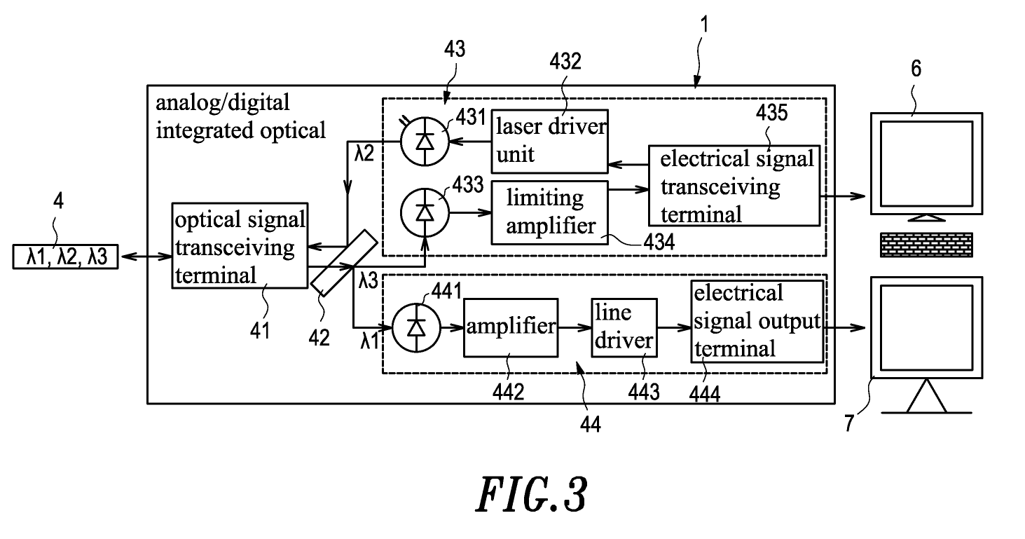

FIG. 3 illustrates another block diagram of the present invention. The module 1 with both analog and digital receiving-transmitting comprises devices as follows:

an optical signal transceiving terminal 41, being configured to transceive a first optical signal and receive a second optical signal, wherein the first optical signal is a digital optical signal, and the second optical signal is a simulated optical signal;

a wavelength division unit 42, being configured to divide the first optical signal transceived and the second optical signal having different bandwidths;

a first optical-to-electrical transceiver unit 43, being connected to the wavelength division unit 42 for converting the first optical signal, and transceiving a first electrical signal, wherein the first electrical signal is a digital electrical signal;

a second optical-to-electrical output unit 44, being connected to the wavelength division unit 42 for converting the second optical signal, and outputting a second electrical signal, wherein the second electrical signal is an analog electrical signal.

The first optical-to-electrical transceiver unit 43 comprises:

a laser emit diode (LED) 431;

a laser driver unit 432, being configured to receive the first electrical signal to drive the LED 431, and to emit the first optical signal via the optical signal transceiving terminal 41;

an photo detector 433, having a trans-impedance amplifier, TIA, being configured to transfer the first optical signal into a voltage signal;

a limiting amplifier 434, being configured to transfer the voltage signal into a differential signal; and

an electrical signal transceiving terminal 435, being configured to transceive the differential signal through the electrical signal transceiving terminal 435.

The second optical-to-electrical output unit 44 comprises:

an photo detector 441, being configured to transfer the second optical signal into a current signal;

an amplifier 442, being configured to amplify the current signal;

a line driver 443, being configured to drive the current signal; and

a electrical signal output terminal 444, being adapted to output the current signal as a second electrical signal.

The structure shown in FIG. 3 is similar to the structure shown in FIG. 2, and the main difference is that the both the computer data transceiving signals with wavelength λ2 and λ3 and the cable TV signals with wave length λ1 are received via the single optical signal transceiving terminal 41 and enter into the module 1 with both analog and digital receiving-transmitting. Then the wavelength division unit 42 set independently is configured to divide the data optical signals belonging to the computer 6 and the optical signals belonging to the cable TV 7. And the divided signals are sent into the first optical-to-electrical transceiver unit 43 and the second optical-to-electrical output unit 44 respectively for optical-to-electrical signal transmission process. Thus the connection element set at the optical signal receiving terminal 31 shown in FIG. 2 can be omitted to save occupying space of the module 1 with both analog and digital receiving-transmitting. According to the aforementioned structure, the data communication of the computer 6 and the signal transmission of the cable TV 7 both take design of wavelength division multiplexing (WDM). That is, the That is, the digital optical signal applied in communication transmission in the optical fiber 4 is able to carry signals with two wavelength λ1, λ2 and λ3 of to make use of bandwidth of the optical fiber. The digital optical signal with λ2 emitted by the LED 431 and the digital optical signal with λ3 fed into the photo detector 433 are divided by the wavelength division unit 42.

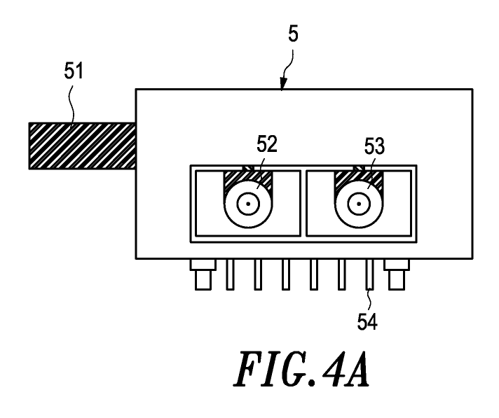

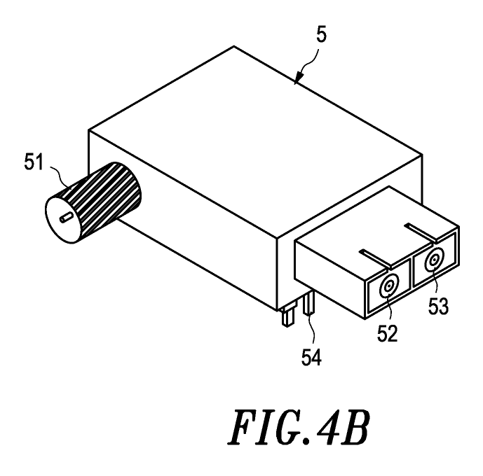

FIG. 4A and FIG. 4B illustrate the front view diagram and the three-dimensional diagram of the module with both analog and digital receiving-transmitting of the present invention respectively. According to the present invention, the structure comprises:

a module 5, the module 5 being set with an output interface connector unit 51 at the side for connection, two plug connectors being set below the module, in which one is a digital optical fiber interface plug connector 52 of the optical signal transceiving terminal, and another one is an analog optical fiber interface plug connector 53 of the optical signal receiving terminal; the cord connector being configured to be connected to the plug connectors is selected from groups of dual-SC-type connector head, dual-ST-type connector head, dual-FC-type connector head, and dual-LC-type connector head, the output interface connector unit 51 of the electrical signal output terminal being composed of pin-type head for transmitting data via the pins.

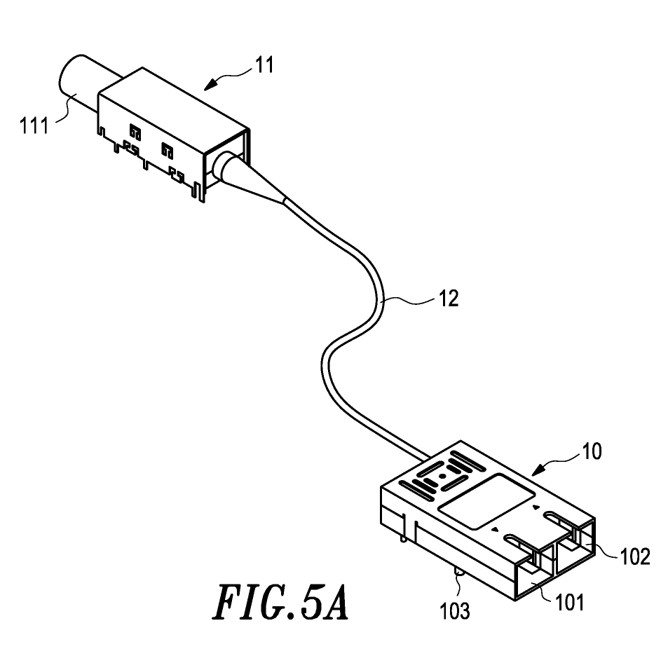

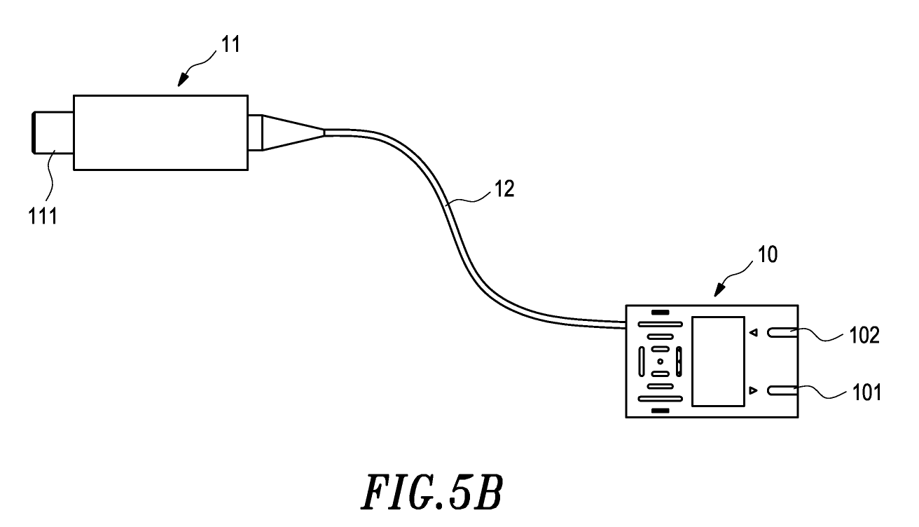

FIG. 5A and FIG. 5B are three-dimensional diagram and planer diagram of the module with both analog and digital receiving-transmitting of the present invention. According to the present invention, the structure comprises:

a module 10 with both analog and digital receiving-transmitting and a second optical-to-electrical output unit 11, the module 10 with both analog and digital receiving-transmitting having two plug connectors in front, in which one is a digital optical fiber interface plug connector 101 of the optical signal transceiving terminal, and another one is an analog optical fiber interface plug connector 102 of the optical signal receiving terminal; the two plug connectors being connected to the cord connector of the optical fiber for transmitting signal from the optical fiber to the module, the cord connector of the optical fiber is selected from groups of dual-SC-type connector head, dual-ST-type connector head, dual-FC-type connector head, and dual-LC-type connector head.

The module 10 with both analog and digital receiving-transmitting has a transceiving interface connector unit 103 of the electrical signal transceiving terminal being composed of pin-type head for transmitting data via the pins.

The module 10 with both analog and digital receiving-transmitting has a signal transmission line 12 in back for being connected to the second optical-to-electrical output unit 11. The second optical-to-electrical output unit 11 has an output interface connector unit 111 of the electrical signal output terminal in front. The output interface connector unit 111 of the electrical signal output terminal is composed of a F-type connector.

The optical signal from the module 10 with both analog and digital receiving-transmitting are transmitted to the second optical-to-electrical output unit 11 via the signal transmission line 12. The second optical-to-electrical output unit 11 receives the optical signal and transfers the optical signal into an electrical signal for transmitting the electrical signal to the cable TV 7.

Through the designs of the present invention, the module 1 with both analog and digital receiving-transmitting is configured to integrate analog optical-to-electrical units and digital optical-to-electrical units and each signal transceiving terminal. The system manufacturers are easy to design FTTH products without dealing with complex analog/digital optical-to-electrical signal conversion. Moreover, optical communication modules are highly integrated in the module with both analog and digital receiving-transmitting to abruptly reduce the occupied space, and the user only needs to buy single product.

The aforementioned descriptions are illustrative and not intended to limit the present invention. Many changes and modifications in the above described embodiment of the invention can, of course, be carried out without departing from the scope thereof and shall be covered within the scope of the claims of the present invention but not the aforementioned embodiments.

### INDUSTRIAL APPLICABILITY

Through the designs of the present invention, the module with both analog and digital receiving-transmitting is configured to integrate analog optical-to-electrical units and digital optical-to-electrical units and each signal transceiving terminal. The system manufacturers are easy to design FTTH products without dealing with complex analog/digital optical-to-electrical signal conversion. Moreover, optical communication modules are highly integrated in the module with both analog and digital receiving-transmitting to abruptly reduce the occupied space, and the user only needs to buy single product.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A module with both analog and digital receiving-transmitting, characterized in that it comprises:
an optical signal transceiving terminal, being configured to transceive a first optical signal;
a wavelength division unit, being configured to divide the first optical signal transceived by the transceiving terminal with different wavelengths, and being wavelength division multiplexing, WDM;
a first optical-to-electrical transceiver unit, being connected to the optical signal transceiving terminal for converting the first optical signal, and transceiving a first electrical signal;
an optical signal receiving terminal, being configured to receive a second optical signal;
a second optical-to-electrical output unit, being connected to the optical signal receiving terminal for converting the second optical signal, and outputting a second electrical signal.

2. The module with both analog and digital receiving-transmitting as claimed in claim 1, characterized in that the first optical signal is a digital optical signal.

3. The module with both analog and digital receiving-transmitting as claimed in claim 1, characterized in that the second optical signal is a simulated optical signal.

4. The module with both analog and digital receiving-transmitting as claimed in claim 1, characterized in that the first electrical signal is a digital electrical signal.

5. The module with both analog and digital receiving-transmitting as claimed in claim 1, characterized in that the second electrical signal is an analog electrical signal.

6. The module with both analog and digital receiving-transmitting as claimed in claim 1, characterized in that the first optical-to-electrical transceiver unit comprises:
a laser emit diode (LED);
a laser driver unit, being configured to receive the first electrical signal to drive the LED, and to emit the first optical signal via the optical signal transceiving terminal;
an photo detector, having a trans-impedance amplifier, TIA, that is configured to transfer the first optical signal into a voltage signal;
a limiting amplifier, being configured to transfer the voltage signal into a differential signal; and
an electrical signal transceiving terminal, being configured to transceive the differential signal.

7. The module with both analog and digital receiving-transmitting as claimed in claim 1, characterized in that the second optical-to-electrical output unit comprises:
an photo detector, being configured to transfer the second optical signal into a current signal;
an amplifier, being configured to amplify the current signal;
a line driver, being configured to drive the current signal; and
a electrical signal output terminal, being adapted to output the current signal as a second electrical signal.

8. The module with both analog and digital receiving-transmitting as claimed in claim 7, characterized in that the electrical signal output terminal is set with an output interface connector unit.

9. The module with both analog and digital receiving-transmitting as claimed in claim 8, characterized in that the output interface connector unit is composed of a F-type connector.

10. The module with both analog and digital receiving-transmitting as claimed in claim 1, characterized in that the output signal transceiving terminal is set with an optical interface connector head for connection.

11. The module with both analog and digital receiving-transmitting as claimed in claim 10, characterized in that the optical interface connector head is selected from groups of dual-SC-type connector head, dual-ST-type connector head, dual-FC-type connector head, and dual-LC-type connector head.

12. The module with both analog and digital receiving-transmitting as claimed in claim 1, characterized in that the optical signal receiving terminal is set with an optical interface connector head for connection.

13. The module with both analog and digital receiving-transmitting as claimed in claim 12, characterized in that the optical interface connector head is selected from groups of dual-SC-type connector head, dual-ST-type connector head, dual-FC-type connector head, and dual-LC-type connector head.

14. The module with both analog and digital receiving-transmitting as claimed in claim 1, characterized in that the electrical signal transceiving terminal is set with a transceiving interface connector unit.

15. The module with both analog and digital receiving-transmitting as claimed in claim 14, characterized in that the transceiving interface connector unit is composed of pin-type head.

16. A module with both analog and digital receiving-transmitting, characterized in that it comprises:
an optical signal transceiving terminal, being configured to transceive a first optical signal and receive a second optical signal;
a wavelength division unit, being configured to divide the first optical signal transceived and the second optical signal having different bandwidths;
a first optical-to-electrical transceiver unit, being connected to the wavelength division unit for converting the first optical signal, and transceiving a first electrical signal;
a second optical-to-electrical output unit, being connected to the wavelength division unit for converting the second optical signal, and outputting a second electrical signal.

17. The module with both analog and digital receiving-transmitting as claimed in claim 16, characterized in that the first optical signal is a digital optical signal.

18. The module with both analog and digital receiving-transmitting as claimed in claim 16, characterized in that the second optical signal is a simulated optical signal.

19. The module with both analog and digital receiving-transmitting as claimed in claim 16, characterized in that the first electrical signal is a digital electrical signal.

20. The module with both analog and digital receiving-transmitting as claimed in claim 16, characterized in that the second electrical signal is an analog electrical signal.

21. The module with both analog and digital receiving-transmitting as claimed in claim 1, characterized in that the first optical-to-electrical transceiver unit comprises:
a laser emit diode (LED);
a laser driver unit, being configured to receive the first electrical signal to drive the LED, and to emit the first optical signal via the optical signal transceiving terminal;
an photo detector, having a trans-impedance amplifier, TIA, being configured to transfer the first optical signal into a voltage signal;
a limiting amplifier, being configured to transfer the voltage signal into a differential signal; and
an electrical signal transceiving terminal, being configured to transceive the differential signal.

22. The module with both analog and digital receiving-transmitting as claimed in claim 21, characterized in that the electrical signal output terminal is set with a transceiving interface connector unit.

23. The module with both analog and digital receiving-transmitting as claimed in claim 22, characterized in that the transceiving interface connector unit is composed of pin-type head.

24. The module with both analog and digital receiving-transmitting as claimed in claim 16, characterized in that the second optical-to-electrical output unit comprises:
an photo detector, being configured to transfer the second optical signal into a current signal;
an amplifier, being configured to amplify the current signal;
a line driver, being configured to drive the current signal; and
a electrical signal output terminal, being adapted to output the current signal as a second electrical signal.

25. The module with both analog and digital receiving-transmitting as claimed in claim 74, characterized in that the electrical signal output terminal is set with an output interface connector unit.

26. The module with both analog and digital receiving-transmitting as claimed in claim 25, characterized in that the output interface connector unit is composed of a F-type connector.

27. The module with both analog and digital receiving-transmitting as claimed in claim 16, characterized in that the output signal transceiving terminal is set with an optical interface connector head for connection.

28. The module with both analog and digital receiving-transmitting as claimed in claim 27, characterized in that the optical interface connector head is selected from groups of dual-SC-type connector head, dual-ST-type connector head, dual-FC-type connector head, and dual-LC-type connector head.
